(19) United States
(12) Patent Application Publication
(10) Pub. No.: US 2010/0272131 A1
(43) Pub. Date: Oct. 28, 2010

(54) DIODE-PUMPED CONTINUOUS LASER DEVICE INCLUDING TWO FILTERS

(76) Inventor: Thierry Georges, Perros-Guirec (FR)

Correspondence Address: GREER, BURNS & CRAIN, 300 S WACKER DR, 25TH FLOOR, CHICAGO, IL, 60606, US

(21) Appl. No.: 12/294,534

(22) PCT Filed: Mar. 30, 2007
(86) PCT No.: PCT/FR07/00551

§ 371 Date: Jul. 12, 2010

(30) Foreign Application Priority Data
Mar. 31, 2006 (FR) 0602794

(51) Int. Cl. H01S 3/098

(52) U.S. Cl. 372/18

(57) ABSTRACT

A continuous laser device including: an amplifying element, at least two birefringent filters or intracavity Lyot filters allowing a single-frequency laser emission; these two Lyot filters being constituted by a polarizing element sandwiched between two birefringent elements; the first Lyot filter having a Free Spectral Range value FSR1 substantially equal to the laser emission bandwidth of the amplifying element; and the second Lyot filter having a Free Spectral Range value FSR2 different from FSR1.

The present invention relates to a diode-pumped laser device comprising an amplifying medium and intra-cavity means allowing the laser emission to be rendered single-frequency.

The document WO 2005/036703, “Laser diode-pumped monolithic solid state laser device and method for application of said device” is known, in which a laser device is described, comprising an amplifying crystal cut at the Brewster angle and a birefringent frequency-doubling crystal. The crystals are arranged so as to allow a single-frequency emission.

Laser devices are also known into which a birefringent filter or Lyot filter formed by a polarizer and a birefringent crystal is inserted so as to render the laser emission single-frequency. In such devices, the FSR (Free Spectral Range) of the Lyot filter is approximately equal to the width of the emission line in order to be sure to have only one single peak in the emission line. The width of the filter is proportional to the FSR. However, it may be that the emission line is too wide (several nm) and therefore the width of the filter is too wide to ensure a selection between two consecutive axial modes. This may be the case with Nd:YVO₄ with its 1064 nm transition. It may also be that the amplifying medium possesses several transitions having wavelengths which are too close to be correctly attenuated by dichroic mirrors of the laser cavity. This is in particular the case with Nd:YAG with its 1053 nm, 1061 nm, 1064 nm, 1073 nm and 1078 nm transitions.

The purpose of the present invention is to deal with the above-mentioned drawbacks by proposing a novel highly selective single-frequency laser device. Another purpose of the present invention is to design a laser device which allows lasing at wavelengths with a very small effective emission cross-section or selection of one transition from several very close transitions.

At least one of the abovementioned objectives is achieved with a diode pumped continuous laser device comprising:
an amplifying element,
at least two birefringent filters or intracavity Lyot filters allowing a single-frequency laser emission; these two Lyot filters being constituted by a polarizing element sandwiched between two birefringent elements; the first Lyot filter having a Free Spectral Range value FSR1 substantially equal to the width of the laser emission band of the amplifying element; and the second Lyot filter having a Free Spectral Range value FSR2 different from FSR1.

The laser device according to the invention is equipped with mirrors suitably arranged to constitute a laser cavity.

As regards the Free Spectral Range, the correct FSR1 order of magnitude of the first Lyot filter is the emission width Δλₑₘ of the amplifying medium (FSR1=kΔλₑₘ with 0.5<k<1.5). This tends to maintain a single transmission peak of the filter in the emission width.

It will be recalled that

$$FSR = \frac{{λ}^{2}}{2 \sum δ {n}_{i} {e}_{i}} ,$$

where eᵢ and δnᵢ are the thicknesses and the index differences of the different birefringent crystals forming the filter considered. The wavelengths at the top of the filter are λₘ=2Σδnᵢeᵢ/m.

The succession of several birefringent elements is generally equivalent to one birefringent element. It is therefore not possible to produce several filters by adding birefringent crystals with different axes. In order to perform several filtering functions, the birefringent elements were separated by a polarizing element. A laser comprising a single polarizing element possesses two zones separated by a polarizer. It is therefore possible to insert two filters by positioning birefringent elements on either side of the polarizer.

The amplifying element can advantageously be Nd:YAG which possesses good thermal characteristics. It is also possible to use Nd:YVO₄ which has the advantage of a wide-band absorption. Other ions are also possible for emissions at different wavelengths.

The polarizing element can be a pair of YAG or silica prisms.

The birefringent element of the first Lyot filter can be a natural material such as YVO₄ which possesses a strong birefringence and therefore a small thickness, quartz or any other birefringent crystal. The birefringent element of the second Lyot filter can be one of the abovementioned crystals or a non-linear birefringent crystal.

This laser device according to the invention therefore comprises two Lyot filters in a laser cavity containing a polarizing element. A first Lyot filter of the order of magnitude of the emission line and a second Lyot filter suited to optimizing the single-frequency emission.

More generally, it is possible to integrate n+1 Lyot filters into a cavity containing n polarizing elements. Such a combination of two Lyot filters with different FSRs makes it possible to obtain a narrow filtering with a large global FSR.

A Lyot filter has the advantage that the wavelength emitted is that for which the losses are smallest and therefore that for which the output polarization of the polarizer is parallel to the axis of least loss. The distribution of the powers between the two axes of the birefringent crystals is therefore perfectly controlled and stable.

Advantageously, the axes of the birefringent elements are oriented at 45° with respect to the axes of the polarizing element. With such a device, the birefringent crystals can be cut and arranged so as to achieve type II phase matching, without the device becoming unstable.

According to a preferential embodiment of the invention, the polarizing element comprises one or two Brewster interfaces (interfaces at an angle between two media with refractive indices n₁ and n₂ such that the tangent of the angle is equal to the ratio of the indices).

In particular, apart from the polarizing element, all the other elements are preferably crystals with parallel faces.

The device according to the invention can advantageously constitute a monolithic linear resonant cavity. Linear cavities are usually the shortest. This small size allows as wide as possible an axial mode separation, which is beneficial to the efficiency of a single-frequency operation. The design of the device can be such that each element comprises an input face and an output face which are parallel to each other and to the other faces of the other elements; these faces being orthogonal to the output direction of the laser beam.

Advantageously, the amplifying medium, the amplifying element, the polarizing element and the birefringent elements are optically in contact with each other, which greatly facilitates the achievement of a single-frequency emission and also reduces the manufacturing costs. It is therefore not necessary to insert focussing elements making it possible to adjust the mode size into the non-linear elements.

In addition in particular to the above, the operating principle of such a laser device integrating two Lyot filters can be defined as follows.

Let us consider the elements modifying the polarization of a cavity with two filters. These are the two birefringent crystals and the polarizer. The Jones matrices describing these elements are

$$C ( δ ) = ( \begin{matrix}{e}^{i δ} & 0 \\ 0 & 1\end{matrix} )$$

for the birefringent elements (in their main polarization axes, δ being the phase shift between the two axes) and

$$P = ( \begin{matrix}1 & 0 \\ 0 & {q}^{2}\end{matrix} )$$

for the polarizing element. For an interface at the Brewster angle between two media of indices n₁ and n₂, we have q²=2n₁n₂/(n₁²+n₂²). For two consecutive interfaces (case of two prisms), this value must be squared.

The two proper polarizations of the cavity are solutions of R₁C₁R₁′PR₂C₂²R₂′P R₁′C₁R₁ e^{2iφ}=μe^{i(δ1+δ2)+2iφ} I where Rᵢ and Rᵢ′ are rotation matrices and their inverses the angles of which correspond to the angle between the axes of the birefringent crystals and the axes of the polarizer, I is the unit matrix and Cᵢ=C(δᵢ). The intensity transmission of these polarization modes is T=|μ|².

The width of the filter is smallest when the two birefringent elements are oriented at 45° to the axes of the polarizer. In particular, the two birefringent crystals are oriented at 45° to the Brewster surfaces.

The Jones matrix corresponding to an out movement in the cavity is then equal to:

$$M = {e}^{iφ} ( \begin{matrix}A & B \\ C & D\end{matrix} ) = {e}^{iφ} ( \begin{matrix}( 1 + {q}^{2} ) {e}^{i ( {δ}_{1} + {δ}_{2} )} & {( 1 - {q}^{2} )}^{{e}^{{iδ}_{1}}} \\ ( 1 - {q}^{2} ) {e}^{{iδ}_{2}} & ( 1 + {q}^{2} )\end{matrix} )$$

The out-and-back movement matrix is then

$${M}_{AR} = {e}^{i2φ} ( \begin{matrix}{A}^{2} + {B}^{2} & AC + BD \\ AC + BD & {C}^{2} + {D}^{2}\end{matrix} )$$

The solutions to the equation M_{AR}=κI (where κ is real) give the polarization modes of the cavity. The value of |κ|² corresponds to the losses of intensity of the cavity. The first laser mode is that for which the losses are smallest. The value of k=μe^{2I(φ+δ1/2+δ2/2)} is the solution of

μ²−bμ+q⁴=0 where b=[(1+q²)² cos(δ₁+δ₂)+(1−q²)² cos(δ₁−δ₂)]/2.

The maximum value of μ is obtained for the maximum value of b. When b>q², μ is real.

The transmission is close to 1 (and therefore the losses are almost zero) when δ₁(λ,T)≈0 [π] and δ₁(λ,T)+δ₂(λ,T)≈0 [2π], As it is in general difficult to adjust δ₁ and δ₂ independently, the maximum transmission point δ₁(λ,T)=0 [π] and δ₁(λ,T)+δ₂(λ,T)=0 [2π] may not be accessible. Around this point, the maximum transmission can be obtained for tg(δ₁)≈0 and tg(δ₂)≈−tg(δ₁)2q²/(1+q⁴).

As the phases φ, δ₁ and δ₂ are at first order (disregarding the wavelength dependency of the refractive indices) inversely proportional to the wavelength λ (φ=a/λ, δ₁=a₁/λ and δ₂=a₂/λ), the wavelengths λₘ of the modes m verify λₘ=(2a+a₁+a₂)/2πm. Moreover the coefficients a depend on the temperature, i.e. aᵢ(T)=a₀ᵢ(1+εᵢ(T−T₀)). As a result, the phases φ, δ₁ and δ₂ are also dependent on the temperature.

Thus, according to an advantageous characteristic, the device according to the invention comprises means for controlling the temperatures of the Lyot filters; these control means being adapted so as to obtain the following relationship in the emission band: δ₁(λ,T)≈0 [π] and δ₁(λ,T)+δ₂(λ,T)≈0 [2π]; with δ₁ and δ₂ being the phase shifts of the first and second birefringent elements at the base of the Lyot filters respectively, λ the wavelength and T the temperature. The temperatures of the different crystals can be adjusted independently, which increases the number of degrees of freedom in the laser settings.

According to a first advantageous variant of the invention, the second Lyot filter is narrower than the first Lyot filter. This second Lyot filter moreover has a Free Spectral Range value FSR2 comprised between the width of the first Lyot filter and the Free Spectral Range value FSR1 of said first Lyot filter.

This first variant makes it possible to increase the selectivity of the filtering inside the band of a transition laser. In fact, a first FSR1 filter of the order of magnitude of the transition bandwidth and a finer second FSR2 filter are chosen. These two filters can be temperature-tuned so as to find a solution to δ₁(λ,T)=0 [π] and δ₁(λ,T)+δ₂(λ,T)=0 [2π] (or equivalently, δ₂(λ,T)=0 [π] and δ₁(λ,T)+δ₂(λ,T)=0[2π]) in the emission band and within a reasonable temperature window (approximately ten degrees). In this case, it is not necessary to “tilt” the filters in order to tune them and therefore this solution is compatible with a monolithic laser design. The application is for example the filtering of a Nd:YVO₄ laser for which the transitions are in general very wide, greater than or equal to 3 nm.

In other words, in this first variant, it was considered that a₁<a₂ (FSR2<FSR1). If a₁/a₂<<1, a wavelength exists for which δ₁(λ)[π]=η<<1 and δ₂(λ) [π]=−2ηq²/(1+q⁴). The value of η is less than πa₁/2a₂. At the filter peak, the transmission is |μ|²≈1−η²(1−q⁴)/(I+q⁴). It is therefore good that the value of is as small as possible and preferably less than 0.1 radian. Beyond this value, the filter losses exceed a few tens of %. The value of η can be reduced by modifying the temperatures of the crystals. The modification of the temperatures of the crystals also makes it possible to adjust the wavelength of one of the modes at the transmission peak of the filter.

According to a second advantageous variant of the invention, the second Lyot filter is wider than the first Lyot filter so as to increase the losses of undesirable wavelengths of the amplifying element. FSR2 can be comprised between 20 and 200 nm. Preferably, the birefringent element of the second Lyot filter is a wave plate (a plate the phase shift δ of which is perfectly determined at one wavelength), for example of quartz.

This second variant applies advantageously to rare earths which generally possess numerous transitions with close wavelengths. Double filtering makes it possible to select one of the transitions while maintaining sufficient selectivity inside the emission band in order to provide a single-frequency operation. This double filtering according to the second variant thus makes it possible to access numerous wavelengths, even those having small effective emission cross-sections. By inserting a wave plate instead of the birefringent element corresponding to the filter with a large FSR, a temperature tuning easily makes it possible to find a solution to δ₂(λ,T)=0 [π] and δ₁(λ/T)+δ₂(λ,T)=0 [2π]

in the emission band, as δ₂ varies little in wavelength and in temperature and cancels out modulo it in the emission band and δ₁ also cancels out modulo 2π in the emission band if the FSR is less than or equal to the emission bandwidth.

In other words and by way of example, the laser cavities allowing a doubling of internal frequency exhibit very small losses at the fundamental wavelength (of the order of 1%). For 4-level transitions, a very small population inversion makes it possible to reach the laser threshold. This means that the “spectral hole burning” or wavelength-selective saturation, allows two close transitions to lase easily, even if the effective emission cross-sections are quite different. The drawback to this is that it can be difficult to prevent a neighbouring transition from oscillating. This is the case with the Nd:YAG laser, which, in addition to the 1064 nm transition, can oscillate simultaneously on the neighbouring transitions (1053 nm, 1061 nm, 1064 nm, 1073 nm or even 1078 nm). The advantage is that it is relatively easy to make a small transition oscillate, such as the 1105 nm, 1112 nm or 1122 nm transitions of Nd:YAG. The second variant according to the present invention makes it possible to suppress transitions situated a few nanometres to a few tens of nanometres from the selected transition.

It is known that the temperature tunability of a Lyot filter obeys the following rule:

$$\frac{\partial λ}{\partial T} + γ λ$$

where γ is a factor intrinsic to the material (the value of which varies from a few 10⁻⁵ to a few 10⁻⁴). This value is therefore independent of the width of the filter. For a wavelength around 1 μm, this corresponds to a tunability varying from 20 pm/K to a few 100 pm/K. This tunability is therefore insufficient to cover the FSR of a filter the FSR of which would be greater than 20 nm. It is therefore improbable that the maximum transmission condition, δ≈0 [π] will be obtained at the laser wavelength. In order to do this, the present invention recommends using a wave plate (in general of quartz) for the filter with a large FSR. The phase shift at the laser wavelength is preferably such that δ=nπ. The larger n, the narrower the filter. This plate can be produced easily using standard wave plate manufacturing techniques. The other filter, in principle narrower (of the order of 1 nm) can be temperature-tuned.

Other advantages and characteristics of the invention will become apparent on examining the detailed description of an embodiment which is in no way limitative, and the attached diagrams, in which:

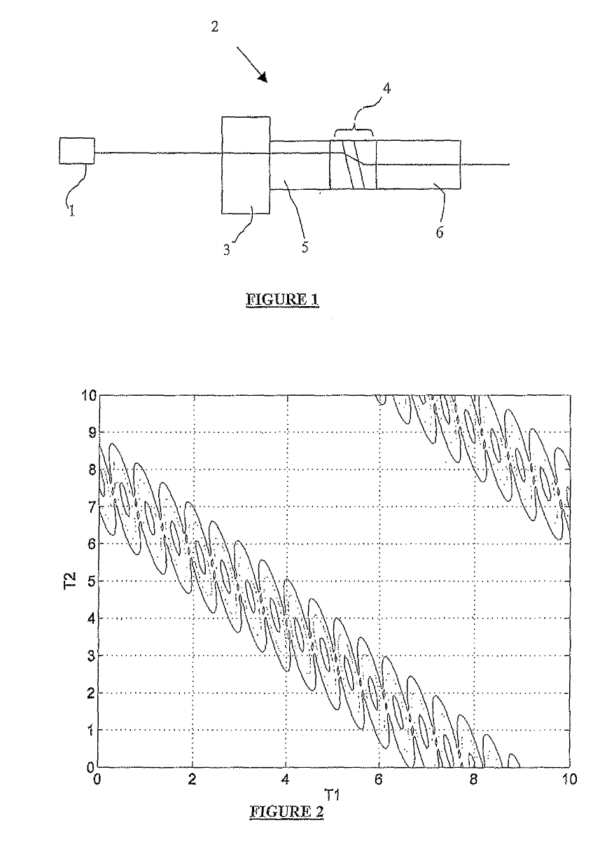

FIG. 1 is a sectional view of the simplified diagram of a device according to the invention,

FIG. 2 is a graphic representation of temperature-transmission-level curves of a device according to the invention in a first implementation variant,

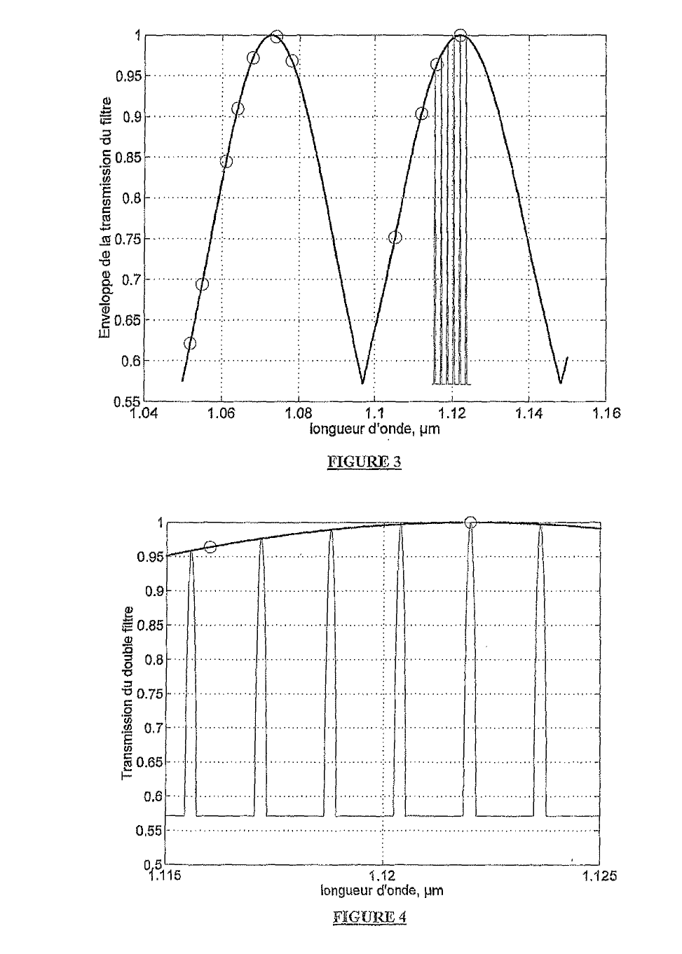

FIG. 3 is a graphic representation of the transmission envelope as a function of wavelength in a laser device according to the invention in a second implementation variant, and

FIG. 4 is a detailed view of a sum of the curve of FIG. 3.

The principle of the Lyot filter is to introduce a birefringent crystal between two polarizers. If a polarizer is inserted into a laser cavity, there are two places available (between the input mirror and the polarizer and between the polarizer and the output mirror) for inserting the birefringent crystal and it is therefore possible to introduce two filters. To introduce more than two filters, a polarizing element must be added for each additional filter.

FIG. 1 shows a diode 1 used to pump the laser device 2 according to the present invention. This laser device 2 is monolithic and comprises the necessary means such as dichroic mirrors for example making it possible to constitute a laser cavity. There can be seen:
a Nd:YAG amplifying crystal 3,
a YVO₄ or quartz crystal 5 or any other birefringent crystal, the birefringence axes of which are preferentially at 45° to the axes of a polarizer 4,
the polarizer 4 is constituted by two prisms cut at the Brewster angle, and
one or more birefringent crystals 6, preferably non-linear, the axes of which are parallel, preferably at 45° to the polarization axes of the polarizer 4.

The first Lyot filter (FSR1) comprises the birefringent crystal 5 in combination with the polarizer 4. The birefringent crystal 5 is arranged between the amplifier 3 and the polarizer 4.

The second Lyot filter (FSR2) comprises the birefringent crystal 6 in combination with the polarizer 4. The birefringent crystal 6 is arranged downstream of the polarizer 4.

The arrangement of the first and second filters can be reversed.

A first variant of the present invention is the design of a “fine” double filtering, which makes it possible to obtain the equivalent of a narrow filter with a large FSR, greater than 1 nm.

This first variant advantageously applies to the case of lasers the transition width of which is large (Nd:YVO₄ for example) or the cavity length of which is large, which requires a better selectivity of the filter.

To do this, a double Lyot filtering is carried out with FSR2 less than FSR1 which is substantially equal to the width of the emission line. For example, a first birefringent element 5 is used, formed from a 4 mm-long “a-cut” YVO₄ crystal. A second birefringent element 6 is used constituted by a 2.5 mm KTP crystal which is cut for the phase matching of the frequency doubling of type II (1064 nm→532 nm).

Each Lyot filter taken separately would have an FSR of 3.1 nm and 0.78 nm. The value of 3.1 nm is of the order of the size of the emission line and this ensures that the filtered mode will have gain. The value of 0.78 nm (adjustable with the length of the YVO₄ crystal) makes it possible to refine the first filter and provide a single-frequency operation.

The exact dependence of the value of μ² (transmission) as a function of temperature requires a submicrometric precision of the lengths of the birefringent crystals. These values vary from one crystal to the another. On the other hand, the topography of μ²(T₁,T₂), where T₁ and T₂ are the temperatures of the two birefringent crystals, remains the same. FIG. 2 shows an example of the behaviour of the double Lyot filter. It illustrates the temperature transmission of the double Lyot filter. The level curves correspond to

T=0.99, 0.995 and 0.999. Each “bubble” corresponds to a mode. The passage from one “bubble” to another means jumping one mode m to a mode m+1 or m−1.

Single-frequency operation is ensured if the temperatures T₁ and T₂ are controlled at the maximum of the fundamental emission. This is preferably done with a control precision better than 0.5° K. (separation between two consecutive modes).

A second variant of the present invention is the design of a laser device in which a transition is selected from several close transitions. This variant can advantageously be applied to a yellow laser (561 nm).

A yellow laser can be produced by means of frequency doubling of the 1122 nm transition of Nd:YAG. The 4-level transition ⁴F_{3/2}→⁴I_{11/2} is at the origin of 12 transitions, the most intense being at 1064 nm. A first transition group is situated between 1052 nm and 1078 nm and a second group is situated beyond 1100 nm: 1105 nm, 1112 nm, 1116 nm and 1122 nm. The first group of wavelengths can be suppressed by means of the dichroic mirror. The selection of one of the four transitions beyond 1100 nm (in the case in point 1122 nm) is preferably made with a Lyot filter with a large FSR.

The doubling crystal is a 5 mm KTP. The type II doubling requires a 45° rotation of the axes relative to the fundamental emission and this non-linear crystal can then serve as a birefringent element for the first Lyot filter. On the other side of the polarizer, a wave plate with a phase shift equal to 20π at 1122 nm is introduced. FIGS. 3 and 4 illustrate the double filtering transmission in the cavity. It can be clearly seen that the double filtering eliminates the three transitions of the second group (1105 nm, 1112 nm and 1116 nm). On the other hand, the fineness of the filtering is well produced by the fineness of the narrow filter. It should be noted that the choice of the 20π phase shift does not allow an effective filtering of the transitions around 1064 nm. The latter are sufficiently distant from 1122 nm to be filtered by the dichroic mirror of the laser. It is also possible to modify the phase shift (for example to 27π) in order to filter all of the transitions.

FIG. 2 shows the band filtering envelope, obtained assuming that in any wavelength the phase δ₁ is optimized in order to achieve the maximum transmission. Around 1122 nm, the double filter transmission is presented. The circles correspond to the wavelengths of the different transitions of Nd:YAG. FIG. 3 illustrates a detail of the double filtering around the wavelength of 1122 nm.

Of course, the invention is not limited to the examples which have just been described, and numerous adjustments can be made to these examples without exceeding the scope of the invention. It is for example possible to conceive the introduction of a Vernier effect with the two filters (if the FSR of one differs from the FSR of the other by only the width of the filters).

1. A continuous laser device comprising:
an amplifying element,
at least two birefringent filters or intracavity Lyot filters allowing a single-frequency laser emission; these two Lyot filters being constituted by a polarizing element sandwiched between two birefringent elements; the first Lyot filter having a Free Spectral Range value FSR1 substantially equal to the laser emission bandwidth of the amplifying element; and the second Lyot filter having a Free Spectral Range value FSR2 different from FSR1.

2. The device according to claim 1, characterized in that it comprises means for controlling the temperatures of the Lyot filters; these control means being adapted so as to obtain the following relationship in the emission band: δ₁(λ,T)≈0 [π] and δ₁(λ,T)+δ₂(λ,T)≈0 [2π]; with δ₁ and δ₂ being the phase shifts of the first and second birefringent elements at the base of the Lyot filters respectively, λ the wavelength and T the temperature.

3. The device according to claim 1, characterized in that the polarizing element comprises one or two Brewster interfaces.

4. The device according to claim 1, characterized in that the two birefringent elements are orientated at 45° to the axes of the polarizing element.

5. The device according to claim 1, characterized in that, apart from the polarizing element, all the other elements are crystals with parallel faces.

6. The device according to claim 1, characterized in that it constitutes a monolithic linear resonant cavity.

7. The device according to claim 1, characterized in that the amplifying element, the polarizing element and the birefringent elements are optically in contact with each other.

8. The device according to claim 1, characterized in that the second Lyot filter is narrower than the first Lyot filter; and in that this second Lyot filter has a Free Spectral Range value FSR2 comprised between the width of the first Lyot filter and the Free Spectral Range value FSR1 of said first Lyot filter.

9. The device according to claim 8, characterized in that the amplifying element is a crystal exhibiting very wide laser transitions greater than or equal to 3 nm.

10. The device according to claim 1, characterized in that the second Lyot filter is wider than the first Lyot filter so as to increase the losses of undesirable wavelengths of the amplifying element.

11. The device according to claim 10, characterized in that the second Lyot filter has a Free Spectral Range value FSR2 comprised between 20 and 200 nm.

12. The device according to claim 10, characterized in that the birefringent element of the second Lyot filter is a wave plate made of quartz.

13. The device according to claim 12, characterized in that the wave plate has a phase shift δ₂ at the emission wavelength such that δ₂=nπ, with n being an integer.
